(19) United States
(12) Patent Application Publication
(10) Pub. No.: US 2011/0202469 A1
(43) Pub. Date: Aug. 18, 2011

(54) FCS SMART TOUCH FOR C LEVEL EXECUTIVES

(75) Inventors: Pushkala VENKATESWARAN, Hyderabad (IN); Venkateswaran VENKATASUBRAMANIAN, Hyderabad (IN); Vikas BANSAL, Cupertino, CA (US); Vikram TAKRU, Cupertino, CA (US)

(73) Assignee: Frontline Consulting Services Private Limited, Hyderabad (IN)

(21) Appl. No.: 12/707,680

(22) Filed: Feb. 18, 2010

(51) Int. Cl. G06F 3/048; G06Q 10/00; G06F 3/041

(52) U.S. Cl. 705/301; 715/776; 345/173

(57) ABSTRACT

Graphical business intelligence tool. An example of a method for providing graphical business intelligence (BI) tool with a touch screen user interface includes receiving user authentication information and displaying one or more briefing books. The method includes displaying one or more chapters associated with the one or more briefing books. The method includes displaying maps, images and layouts associated to the one or more chapters. The method includes presenting Business Intelligence reports that take input from the maps, the images and, the layouts. The method includes allowing the one or more briefing books, chapters, measures, features, BI Reports to be configured. The method also includes creating graphical representations of dimensions used by a vertical, enabling graphical navigation capabilities in the graphical BI tool, calibrating the touch screen user interface with the graphical BI tool, and deploying the graphical BI tool with the touch screen user interface.

### FIELD

The present disclosure relates to a graphical, touch enabled business intelligence tool.

### BACKGROUND

Business intelligence (BI) systems are systems used for decision making. Often, business intelligence systems include decision support systems (DSS) and executive information systems (EIS). Most available BI systems represent one or more verticals that provide information to executives at all levels. A vertical represents a group of similar functions related to a business unit, for example HR Analytics or Supply Chain Analytics.

In an existing BI system, an interactive web architecture dashboard displays required information to help a users' decision making. In one example, the user can be a C level executive. In another example, access to the required information is interactive and is based on the user's role and identity. In yet another example, the user works with live reports, charts, tables, prompts, pivot tables, and graphics and the user can modify and interact with results. Often, the user desires to configure the BI system and work with the BI system in an interactive manner. Further, it may be desired to provide targeted information to C level executives and also enable the C level executives to refresh or update report data by graphical means.

In light of foregoing discussion there is a need for an efficient technique for representing Business Intelligence information for the C Level Executives.

### SUMMARY

Embodiments of the present disclosure described herein provide a graphical business intelligence tool.

An example of a method for providing graphical business intelligence (BI) tool with a touch screen user interface includes receiving user authentication information. Further, the method includes displaying one or more briefing books. Furthermore, the method includes displaying one or more chapters associated with the one or more briefing books. The method includes displaying maps, images and layouts associated to the one or more chapters. Further, the method includes presenting Business Intelligence reports that take input from the maps, the images and, the layouts. In addition, the method includes allowing the one or more briefing books, chapters, measures, features, BI Reports to be configured. The method includes creating graphical representations of dimensions used by a vertical. Further, the method includes enabling graphical navigation capabilities in the graphical BI tool. The method includes calibrating the touch screen user interface with the graphical BI tool. The method further includes deploying the graphical BI tool with the touch screen user interface.

An example of a system for providing graphical business intelligence (BI) tool with a touch screen user interface includes a touch screen enabled electronic device. The touch screen enabled electronic device includes a communication interface in electronic communication with one or more user devices. The touch screen enabled electronic device further includes a processor for executing one or more instructions that causes the processor for receiving user authentication information, displaying one or more briefing books, displaying one or more chapters associated with the one or more briefing books, displaying maps, images and layouts associated to the one or more chapters, presenting Business Intelligence reports that take input from the maps, the images and, the layouts, allowing the one or more briefing books, chapters, measures, features, BI Reports to be configured, creating graphical representations of dimensions used by a vertical, enabling graphical navigation capabilities in the graphical BI tool, calibrating the touch screen user interface with the graphical BI tool, and deploying the graphical BI tool with the touch screen user interface.

### BRIEF DESCRIPTION OF FIGURES

FIG. 1 is a block diagram of a system for providing a graphical BI tool, in accordance with which various embodiments can be implemented;

FIG. 2 is a flow chart illustrating usage of a graphical Business Intelligence (BI) tool.

FIG. 3 is a flow chart illustrating steps involved in configuring a graphical Business Intelligence (BI) tool.

FIG. 4A is a snapshot of a graphical BI tool, in accordance with one embodiment;

FIG. 4B is a snapshot of a graphical BI tool, in accordance with another embodiment;

FIG. 5 is a snapshot of a graphical BI tool, in accordance with yet another embodiment;

FIG. 6 is a snapshot of a graphical BI tool, in accordance with another embodiment;

FIG. 7 is a snapshot of a graphical BI tool, in accordance with yet another embodiment; and

FIG. 8 illustrates an entity relationship flowchart of a graphical BI tool, in accordance with one embodiment.

### DETAILED DESCRIPTION OF THE EMBODIMENTS

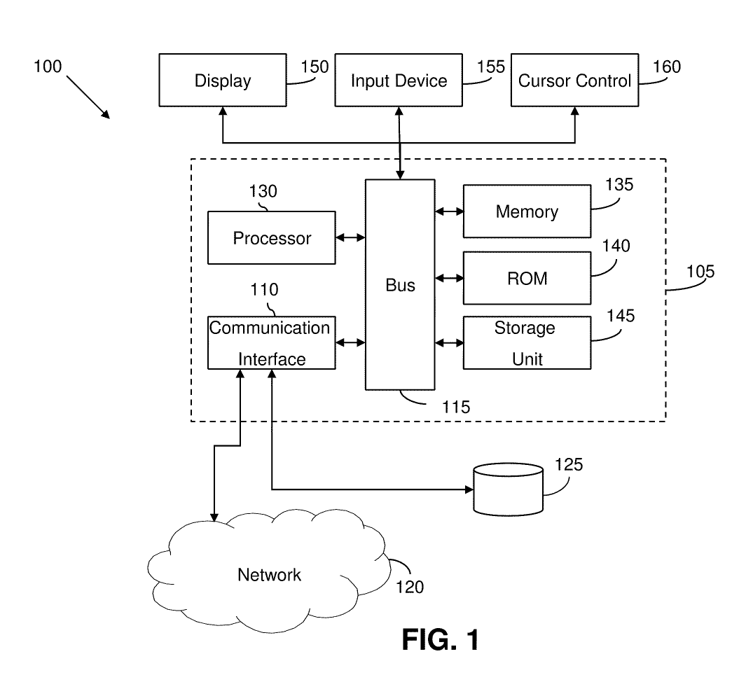

FIG. 1 is a system 100 for providing a graphical business intelligence (BI) tool. The system 100 includes an electronic device 105. Examples of the electronic device include, but are not limited to, a computer, a mobile phone, a laptop, a palmtop, and a personal digital assistant (PDA). In one embodiment, the electronic device 105 can be a touch screen enabled electronic device. The electronic device 105 also includes a communication interface 110 coupled to a bus 115 for enabling data communication. Examples of the communication interface 110 include, but are not limited to, an integrated services digital network (ISDN) card, a modem, a local area network (LAN) card, an infrared port, a Bluetooth port, a zigbee port, and a wireless port.

The electronic device 105 is coupled to a network 120 through the communication interface 110. Examples of the network 120 include, but are not limited to, a Local Area Network (LAN), a Wireless Local Area Network (WLAN), a Wide Area Network (WAN), wired network, wireless network, internet and a Small Area Network (SAN). Examples of a protocol used for communication by the electronic devices 105 include, but are not limited to, internet protocol, wireless application protocol (WAP) and any other protocol applicable for communicating data in the network 120. The electronic device 105 is connected to a database 125 though the communication interface 110.

The electronic device 105 includes the bus 115 for communicating information, and a processor 130 coupled with the bus 115 for processing information. The electronic device 105 also includes a memory 135, for example a random access memory (RAM) coupled to the bus 115 for storing instructions to be executed by the processor 130. The memory 135 can be used for storing temporary information required by the processor 130. The electronic device 105 further includes a read only memory (ROM) 140 coupled to the bus 115 for storing static information and instructions for the processor 130. A storage unit 145, for example a magnetic disk, hard disk or optical disk, can be provided and coupled to bus 115 for storing information and instructions.

The electronic device 105 can be coupled via the bus 115 to a touch screen display 150. A user can configure the BI tool using the touch screen display 150. In one example, the user can configure the BI tool using finger. In another example, the user can configure the BI tool using a stylus.

In some embodiments, an input device 155, including various keys, is coupled to the bus 115 for communicating information and command selections to the processor 130. In some other embodiments, a cursor control 160, for example a mouse, a trackball, a joystick, or cursor direction keys for command selections to the processor 130 and for controlling cursor movement on the display 150 can also be present. The input device could also be biometric readers. In the case of the display 150 being a touch screen, the input device 155 comes coupled with the touch screen.

In one embodiment, the steps of the present disclosure are performed by the electronic device 105 in response to the processor 130 executing instructions included in the memory 135. The instructions can be read into the memory 135 from a machine-readable medium, for example the storage unit 145. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The storage unit 145 can be a non-volatile media. The memory 135 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 130.

In one embodiment, a touch screen enabled electronic device includes a processor for executing one or more instructions that causes the processor 130 for receiving user authentication information, displaying one or more briefing books, displaying one or more chapters associated with the one or more briefing books, displaying maps, images and layouts associated to the one or more chapters, presenting Business Intelligence reports that take input from the maps, the images and, the layouts, allowing the one or more briefing books, chapters, measures, features, BI Reports to be configured, creating graphical representations of dimensions used by a vertical, enabling graphical navigation capabilities in the graphical BI tool, calibrating the touch screen user interface with the graphical BI tool, and deploying the graphical BI tool with the touch screen user interface. A vertical represents a group of similar functions related to a business unit, for example HR Analytics or Supply Chain Analytics.

The processor 130 receives user authentication information like username and password (or) biometric scan. The user name is associated to one or more briefing books through roles. Each briefing book is associated to one or more chapters and each chapter is associated with a graphical display like a map, organization chart, plant layout etc. The one or more briefing books can be functional areas. Example, of the function areas include, but are not limited to, data of at least one of human resource management, manufacturing intelligence, supply chain management, finance, marketing management, account management, and sales management.

The one or more briefing books may be one or more verticals or domains pertaining to one or more functional areas. The processor 130 is responsible for generating a graphical BI tool for at least one briefing book by configuring the briefing books. Further, the processor 130 is capable of figuring out the chapters associated with the briefing books. Chapters are maps or starting points under a briefing book. Examples, of the chapters include, but are not limited to Asia Pacific, Europe, the Middle East and Africa, Middle East etc. The processor 130 is also capable of creating and configuring graphical representations for displaying the chapters in the graphical BI tool. In one example, the graphical representations can be created and configured using shock wave flash (SWF) technology. The processor 130 also enables one or more drill downs and graphical navigation capabilities in the graphical BI tool. The processor 130 also calibrates and configures a touch screen user interface with the graphical BI tool and deploys the graphical BI tool with the touch screen user interface to the user. The graphical BI tool can include one or more sections being displayed on the graphical BI tool. For example, the one or more sections may include, but are not limited to, a measure panel, a feature panel, a map area, a report area and a dashboard links.

In some embodiments, a request for providing a graphical BI tool for the briefing book, for example a human resource management system (HRMS) is received by the electronic device 105 from another electronic device through the network 120, hereinafter referred to as second electronic device. In one example, the electronic device 105 is referred as first electronic device. In one embodiment, the second electronic device provides metadata associated with the HRMS to the electronic device 105. The metadata for the HRMS may be number of head counts for a particular office, number of employees joining a company in the month of December, 2009, salary account details, etc.

The processor 130 is capable of identifying the metadata. The processor 130 further generates the graphical BI tool for the HRMS. Once the processor 130 completes processing the graphical BI tool for the HRMS, the graphical BI tool is deployed on the second electronic device through the network 120. In one example, the second electronic device needs to be compatible with SWF software to deploy the graphical BI tool for the HRMS. A user of the second electronic device needs to authenticate for using the graphical BI tool for the HRMS. The authentication may be performed by entering a user name and a password. Once the user is authenticated, the user can use the graphical BI tool for presenting HRMS in a boardroom or for presenting the HRMS in the xyz company to C-level executives.

In some embodiments, the processor 130 can include one or more processing units for performing one or more functions of the processor 130. The processing units are hardware circuitry performing specified functions.

In one embodiment, any configuration, including creating the graphical representations using the shock wave flash technology is done once and is transparent to the end user. The end user (C-level executives) merely use touch sensory medium to click, drag and drop to provide dimensional user input to BI reports. Furthermore, an alerting and exception reporting capabilities of the Smart Touch device wherein the same images/flash objects get highlighted in different colors, for example red, yellow, and green, based on pre-defined targets.

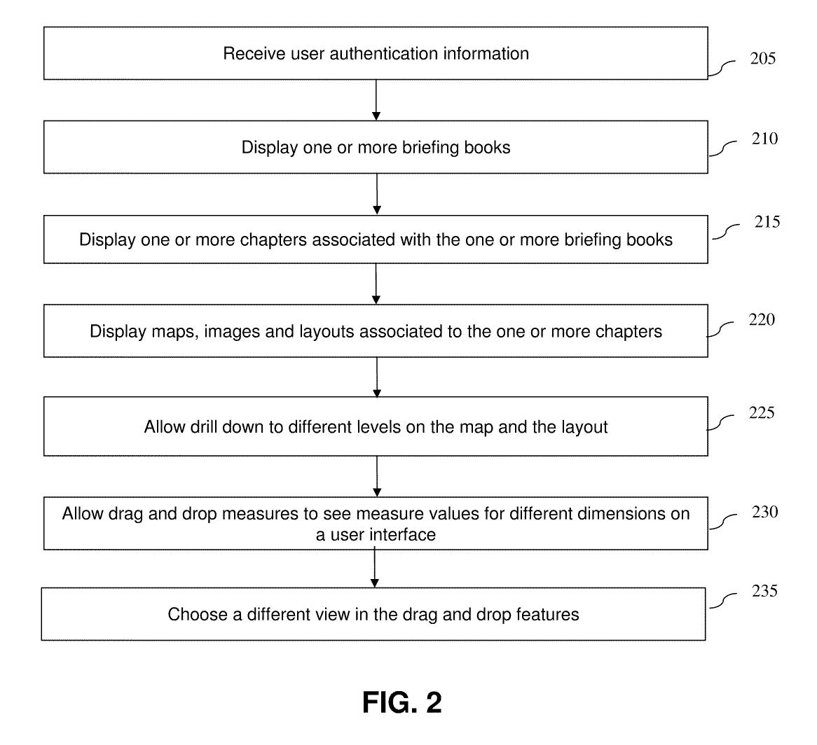

FIG. 2 is a flow chart illustrating usage of a graphical Business Intelligence (BI) tool.

At step 205, user authentication information is received.

At step 210, one or more briefing books are displayed for an end user (C level executive). For example, the electronic device 105 receives a briefing book based on school management. The briefing book includes functional areas of one or more data. Example, of the functional areas having one or more data include, but are not limited to, a human resource management system (HRMS), manufacturing intelligence, supply chain management, finance, marketing management, account management, Project management and sales management.

In one example, the processor 130 is capable of analyzing the one or more briefing books.

At step 215, one or more chapters associated with the one or more briefing books are displayed to the end user. For example, the chapter can be a location wherein the school is situated. A chapter can include a metadata of the data.

In some embodiments, the one or more chapters include one or more maps associated with the one or more briefing books.

In some embodiments, the processor 130 configures feature points, feature panel, measure panel and generates one or more reports based on the configuration.

At step 220, maps, images and layouts associated to the one or more chapters are displayed to the end user.

At step 225, the end user is allowed to drill down to different levels on the map and the layout.

At step 230, the end user is allowed to drag and drop measures to see measure values for different dimensions on a user interface.

At step 235, the end user chooses a different view in the drag and drop features. In one example, the user might be viewing cities for Texas and later the end user might want to view all Walmart stores in Texas. Thus the end user can choose different views for the drag and drop features.

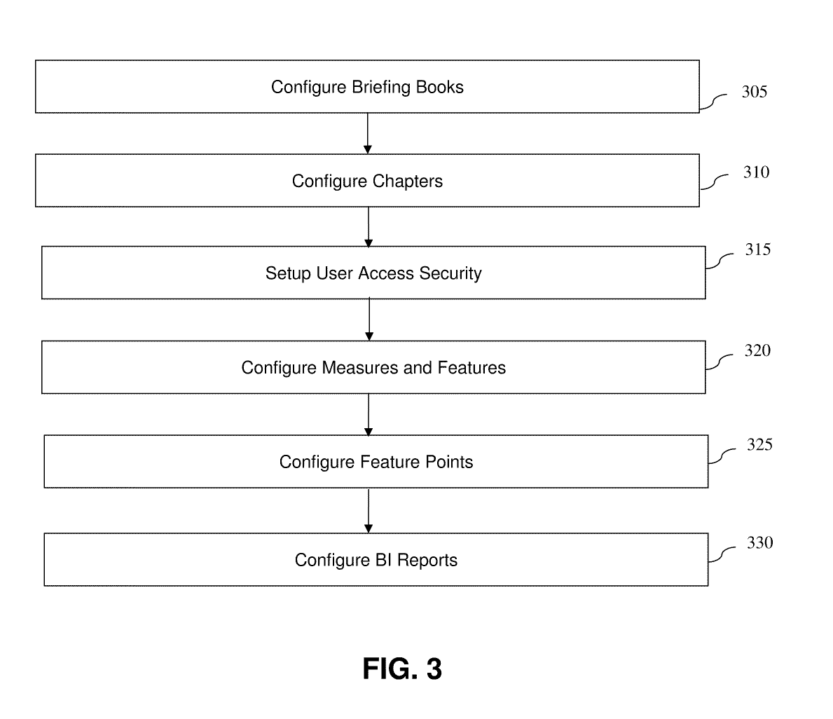

FIG. 3 is a flow chart illustrating steps involved in configuring a graphical Business Intelligence (BI) tool.

At step 305, briefing books are configured. The briefing book includes functional areas of one or more data. Example, of the functional areas having one or more data include, but are not limited to, a human resource management system (HRMS), manufacturing intelligence, supply chain management, finance, marketing management, account management, Project management and sales management.

At step 310, chapters are configured. For example, a chapter can be a location wherein the school is situated. A chapter can include a metadata of the data.

At step 315, user access security is setup. A user authenticates based on the user access security setup while using the BI tool.

At step 320, measures and features are configured. Examples of measures include but are not limited to a trade rate, sales figures, shares, and a promotion rate.

At step 325, feature points are configured.

At step 330, business intelligence (BI) reports are configured.

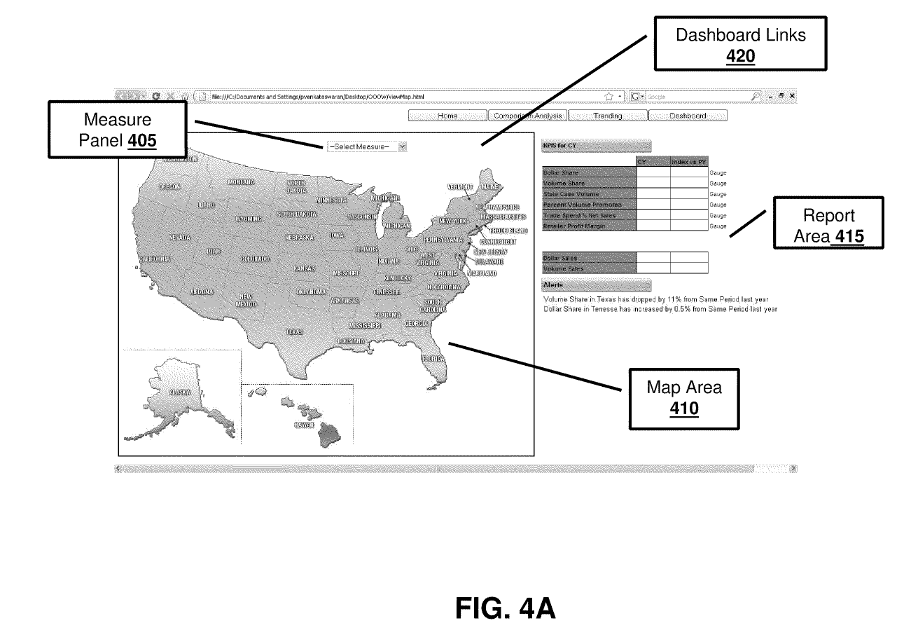

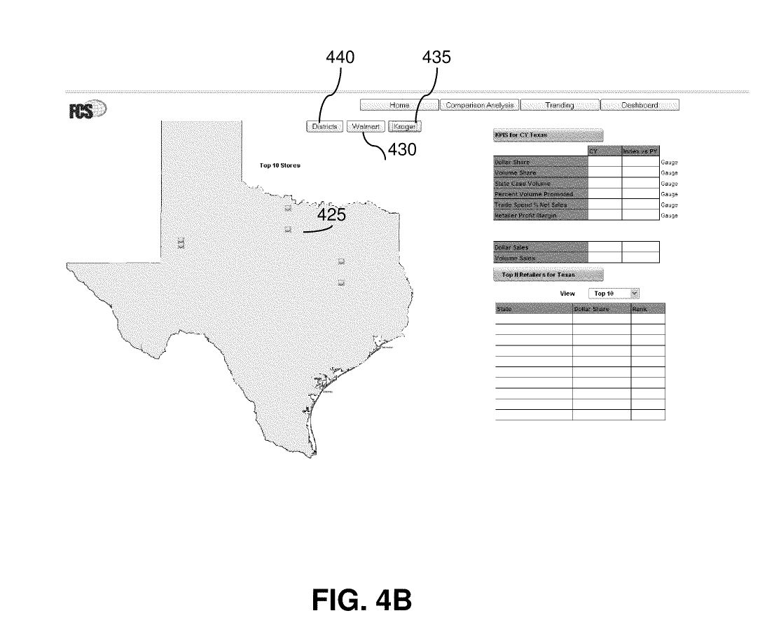

FIG. 4A is a snapshot of a graphical BI tool. The snapshot displays the various sections of the graphical BI tool. Examples of the sections include, but are not limited to, a measure panel 405, a map area 410, a report area 415, and a dashboard links area 420. The measure panel 405 lists measures that can be dragged and dropped onto the map area 410. For example, the measure may be a trade rate, sales figures, shares, a promotion rate etc. The map area 410 displays the map and also allows drill down from map features. In one example, the map area 410 can display map of Texas and further be drilled down to display Wal-Mart stores in Texas. In another example, the map area 410 can display map of Texas and further be drilled down to regions in Texas.

In some embodiments, when the user desires to know the sales measure in state Texas then the user can drag and drop a measure “sales of $10000” listed in the measure panel 305 onto the map of the state Texas. The entire Texas state will be highlighted in green if the sales result is considered as satisfactory. If the sales in the state Texas is $7000 and above, and $7000 being considered as average sales then the entire Texas state will be highlighted in yellow color. Further, if the sales in the state Texas is $5000 or below, and $5000 rate is considered as below average sales, then the entire Texas state will be highlighted in red color. Thus the states getting highlighted can be considered as a key indication of a respective state. The order of selecting colors designated for various key indications can be changes based on the user requirements.

The report area 415 displays reports corresponding to the selected map feature. For example, on a geographical global map, if a measure “sales” is dragged and dropped from the measure panel 405 on Texas, then the report area 415 displays reports pertained to “sales” in Texas.

In some embodiments, a user of the electronic device 105 desires to know the key performance indicators (KPIS) of the state Texas. The user then needs to touch on the state Texas. The report area 415 changes from current state to display the KPIS for the state Texas.

The dashboard links area 420 displays the links and is used to link to the BI dashboards, reports as well as to display Really Simple Syndication (RSS) feeds related to the analytics being performed.

In some embodiments, the user can connect the graphical BI tool to other business intelligence tools, for example, Oracle business intelligence enterprise edition tool. The graphical BI tool can have one or more button on top of the snapshot. If the user clicks on at least one button corresponding to comparison analysis, then the display screen of the electronic device 105 displays the normal report corresponding to other BI tool. Also, the user can come back to the graphical BI tool once the normal report is viewed in other BI tool.

FIG. 4B is another snapshot of a graphical BI tool. The snapshot in the FIG. 4B is the expanded view of the snapshot of FIG. 4A displaying the expanded map of the state Texas when touched by the user or when a measure is dragged and dropped onto the state Texas.

In one example, the user drags and drops a measure, for example, sales figures onto the map of the state Texas. The map of the state Texas expands and is displayed as shown in the snapshot in the FIG. 4B. A user can view different cities (shown as dots 425) of the state Texas. Further, all the dots 425 can change into red, green or yellow color showing various indications representing growth in the sales in each city. The graphical BI tool also displays a Wal-Mart feature 430, Kroger feature 435 and districts feature 440. The user can drag and drop the Wal-Mart feature 430 from there to the colored region (for example, yellow region) of the map. Then the user can view all the list of Wal-Mart stores present in the Texas state. Also, all the Wal-Mart stores present in the Texas state start getting highlighted. The user can further drag and drop predefined measures and is provided with the information regarding which of the Wal-Mart stores is performing well.

The districts feature 440, the dots 425 and Wal-Mart feature 430 together constitute a feature panel.

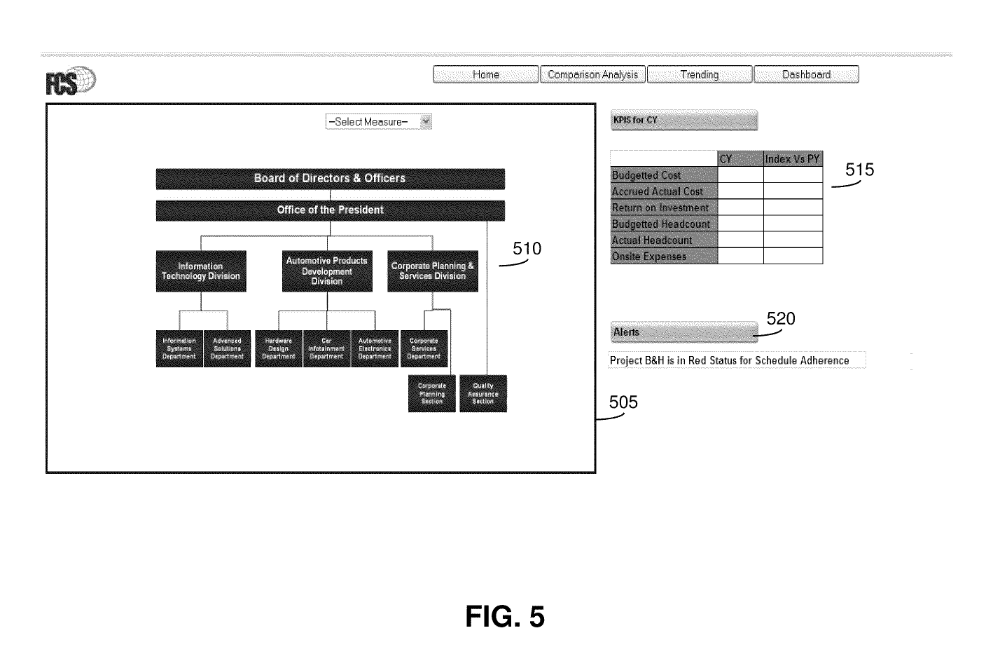

FIG. 5 is yet another snapshot of a graphical BI tool. The snapshot displays a department map area 505 which further allows a user to drill down to projects for project schedule tracking 510. Also, on a report area 515 displays the corresponding reports to the department map area 505. The snapshot also displays an alert notification 520.

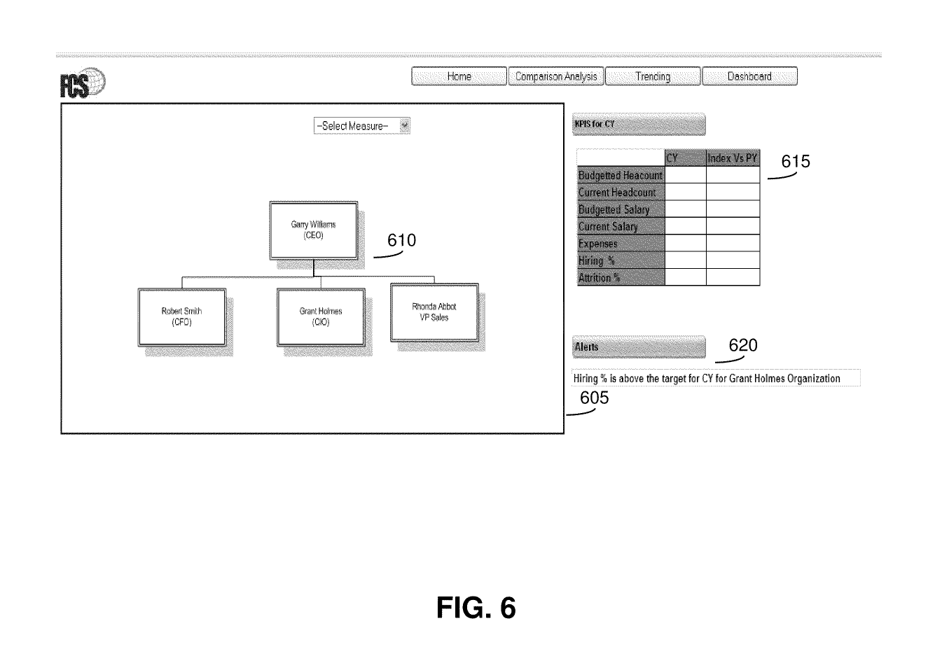

FIG. 6 is also a snapshot of a graphical BI tool. The briefing book can be HRMS. A map area 605 in the graphical BI tool for the HRDS can have an organization chart 610 which can drill down and explode down to lower levels in the hierarchy to see measures. Example, of the measures may include, but are not limited to attrition, expenses, salary paid, budget head count. A report area 615 may display the measures. The snapshot also displays an alert notification 620.

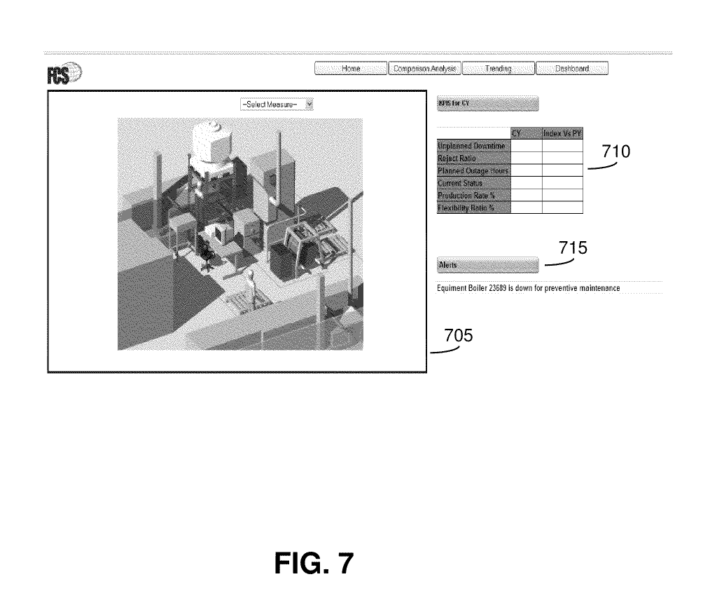

FIG. 7 is also a snapshot of a graphical BI tool. The briefing book can be a manufacturing intelligence. A map area 705 in the graphical BI tool for the manufacturing intelligence displays a manufacturing plant layout. Also the map area 705 allow a user to further drill down to one or more measures, for example an assembly lines and equipments to see the current status (up, running, down), planned outage, unplanned outages. A report area 710 displays various information for example unplanned downtime, and reject ratio. The snapshot also displays an alert notification 715.

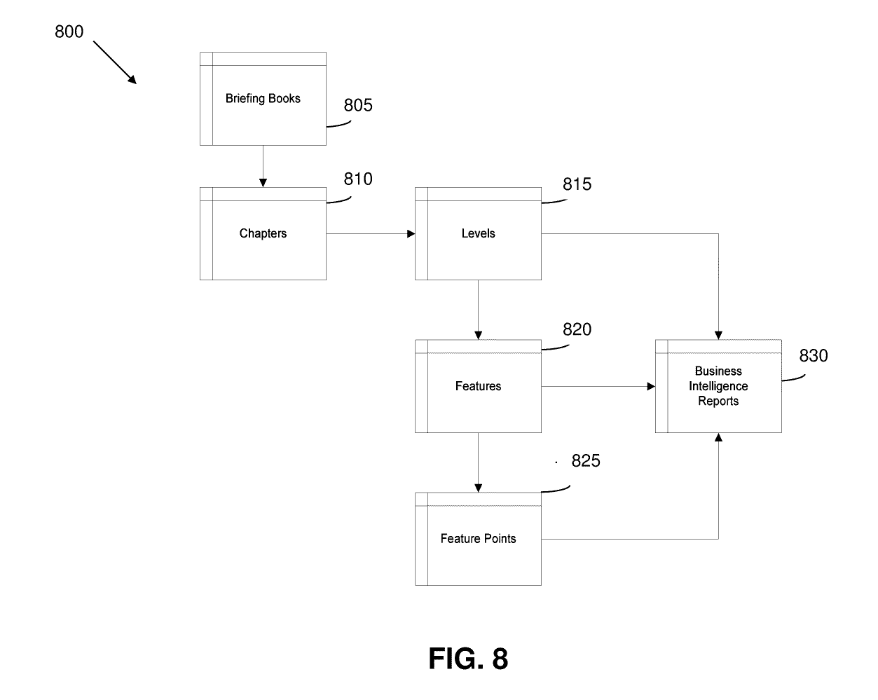

FIG. 8 illustrates an entity relationship flowchart 800 of a graphical BI tool.

The entity relationship flowchart 800 is a high level entity relationship diagram and includes a briefing books 805, chapters 810, level 815, features 820, feature points 825, and business intelligence reports 830. The briefing books 805 may pertain to one or more verticals, for example marketing supply chain, analyzing headcount, return ship ratio, employee morale, financial, profit or loss, and recurring expenses. Briefing books 805 may be the verticals at which a user might want to use the appliance for. The user logs in, initially to get a set of briefing books. For example, the user can get 3 briefing books options: do you want to analyze supply chain, do you want to analyze HRMS, and do you want to analyze finance. Consider the user wants to analyze the supply chain. The user clicks on the supply chain briefing book and that briefing book contains a set of chapters, for example a chapter 810. The chapter 810 may be: “see results in south India particularly” or “start at Asia Pacific” or “see only for America”. There may be different maps, graphical figures that the user may require to analyze the briefing books 805. The maps, graphical figures may be at least two examples from the set of chapters 810. Under each chapter there can be levels 815, for example the user may narrow down from country to state to city. In one embodiment, the levels 815 can be an organizational chart drilled down. The briefing books 805, the chapters 810, the level 815, the features 820, and the feature points 825 are tied to the business intelligence reports 830 as shown in report area 415 of FIG. 4A. The business reports 830 may be any business intelligence report that is published through a web URL like an oracle business intelligence enterprise edition (OBIEE) report. Thus the user can easily view the maps and the respective data can be viewed on the report area 415. If the user needs to drill down onto the map area, the user needs to touch the screen.

In some embodiments, a touch screen application can support any vertical's need by its ability to allow users to upload images, define hotspots on images and configure drill downs to other images.

It is appreciated that the current disclosure describes a graphical BI tool enabled in a touch screen appliance. The various advantages include Actionable Business intelligence delivered via Touch screen, BI prompted from Store Maps, Organizational Charts, Geographic maps and other images, Drive meetings in the Board room easily, Graphical Exception reporting, Interactive maps that display measure values and health, Drag and Drop of Measures and Features onto Map area, Integrated Reports from Oracle Business Intelligence Suite, Easy to configure and Setup and also High Quality Visual Navigations.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method of providing a graphical business intelligence (BI) tool with a touch screen user interface, the method comprising:
receiving user authentication information;
displaying one or more briefing books;
displaying one or more chapters associated with the one or more briefing books;
displaying maps, images and layouts associated to the one or more chapters;
presenting Business Intelligence reports that take input from the maps, the images and the layouts;
allowing the one or more briefing books, chapters, measures, features, and BI Reports to be configured;
creating graphical representations of dimensions used by a vertical;
enabling graphical navigation capabilities in the graphical BI tool;
calibrating the touch screen user interface with the graphical BI tool; and
deploying the graphical BI tool with the touch screen user interface.

2. The method as claimed in claim 1, wherein a briefing book represents a functional area, wherein the functional area comprises data of at least one of human resource management, manufacturing intelligence, supply chain management, finance, marketing management, account management, project management and sales management.

3. The method as claimed in claim 2 and further comprising analyzing the functional area.

4. The method as claimed in claim 2, wherein a chapter represents metadata of the functional area.

5. The method as claimed in claim 1, wherein allowing the briefing books, chapters, measures, features, BI Reports is configured by:
configuring the one or more briefing books; and
configuring one or more chapters associated with the one or more briefing books.

6. The method as claimed in claim 1, wherein the one or more chapters comprises one or more maps.

7. The method as claimed in claim 1 and further comprising
enabling one or more drill downs in the graphical BI tool to view a plurality of images, maps and layouts.

8. The method as claimed in claim 1, wherein creating the graphical representations comprises
configuring the graphical representations to display the one or more chapters in the graphical BI tool.

9. The method as claimed in claim 1, wherein calibrating the touch screen user interface comprises
configuring the touch screen user interface associated with the graphical BI tool.

10. The method as claimed in claim 1 and further comprising:
configuring one or more feature points;
configuring a feature panel;
configuring a measure panel; and
generating one or more reports.

11. The method as claimed in claim 10 and further comprising
publishing the one or more reports through a web Uniform Resource Locator.

12. The method as claimed in claim 1 and further comprising
providing drag and drop facility in the graphical BI tool to alert exception areas.

13. The method as claimed in claim 1, wherein enabling the graphical navigation capabilities comprises
refreshing a current dashboard in the graphical BI tool based on the graphical navigation.

14. A system for providing a graphical business intelligence (BI) tool with a touch screen user interface, the system comprising:
a touch screen enabled electronic device, the touch screen enabled electronic device comprising:
a communication interface in electronic communication with one or more user devices; and
a processor for executing one or more instructions that causes the processor to:
receive user authentication information,
display one or more briefing books,
display one or more chapters associated with the one or more briefing books,
display maps, images and layouts associated to the one or more chapters,
present Business Intelligence reports that take input from the maps, the images and, the layouts,
allow the one or more briefing books, chapters, measures, features, BI Reports to be configured,
create graphical representations of dimensions used by a vertical;
enable graphical navigation capabilities in the graphical BI tool,
calibrate the touch screen user interface with the graphical BI tool, and
deploy the graphical BI tool with the touch screen user interface.

15. The system as claimed in claim 14, wherein the graphical BI tool comprises:
a measure panel;
a feature panel;
a map area;
a report area; and
one or more dashboard links.
